(19) United States
(12) Patent Application Publication
(10) Pub. No.: US 2019/0059429 A1
(43) Pub. Date: Feb. 28, 2019

(54) SALT COMPOSITION INCLUDING SERINE

(71) Applicant: NESTEC S.A., Vevey (CH)

(72) Inventors: Heiko Oertling, Lausanne (CH); Thibaut Alzieu, Lausanne (CH); Walter Matthey-Doret, Prilly (CH); Celine Borlet, Aigueblanche (FR)

(21) Appl. No.: 16/092,593

(22) PCT Filed: Apr. 11, 2017
(86) PCT No.: PCT/EP2017/058635

§ 371 Date: Oct. 10, 2018

(30) Foreign Application Priority Data
Apr. 11, 2016 (EP) 16164631.0

(51) Int. Cl. A23L 27/40; A23L 27/21

(52) U.S. Cl. CPC A23L 27/40; A23V 2002/00; A23L 27/21

(57) ABSTRACT

Disclosed are co-crystals comprising amino acids (such as serine) and sodium chloride, processes for their preparation and nutritional compositions comprising the co-crystals.

### FIELD OF THE INVENTION

The present invention relates to co-crystals comprising amino acids and sodium chloride and to processes for their preparation. The present invention also relates to nutritional compositions comprising serine.sodium co-crystals and to the use of serine.sodium chloride co-crystals for preparing nutritional compositions.

### BACKGROUND TO THE INVENTION

In humans, the sensory system for taste, known as the gustatory system, is responsible for the detection of the flavour molecules and ions present in foods. The gustatory system comprises so-called type I, II and III taste cells, which express different taste receptors, e.g. G-protein coupled receptors or ion channels. These receptors interact with specific molecules or ions derived from ingested substances, thereby eliciting the sensation of taste. Accordingly, the ability to detect a particular taste depends upon the nature of the receptors expressed by taste cells. Typically, five main classes of taste may distinguished: salty, sweet, bitter, sour and umami (Chaudhari and Roper, J. Cell Biol. 2010, Vol. 190, No. 3, 285-296).

The detection and transduction of salty taste stimuli occurs via the direct permeation of sodium ions through ion channels located on (type I) taste cells. This influx of positively charged sodium ions depolarizes the taste cells, thereby initiating an action potential. The most widely studied ion channel involved in the detection of sodium ions is the so-called amiloride-sensitive epithelial Na channel (ENaC). The role of the ENaC was confirmed by a study in which a critical ENaC subunit was knocked out. This resulted in impaired detection of salty tastes. Pharmacological and other evidence suggests that the detection of salty tastes may also be mediated by additional membrane receptors or ion channels, although these remain less well characterised (Chaudhari and Roper, J. Cell Biol. 2010, Vol. 190, No. 3, 285-296).

Taste receptors do not interact with solid foods or polymers (e.g. polypeptides or polysaccharides). Instead, in order to be able to access receptor binding sites, taste eliciting molecules or ions must be dissolved in an aqueous medium (Pedersen et al., Oral Diseases (2002) 8, 117-129). In the case of solid foods this aqueous medium will be mostly provided by saliva. Accordingly, the dissolution behaviour of a solid food in saliva will influence how its taste is perceived.

One measure of dissolution behaviour is solubility, which may be defined as maximum amount of solute that can dissolve per amount of given solvent, at thermodynamic equilibrium. Another measure of dissolution behaviour is the rate of dissolution of a solute in a liquid medium. This kinetic property may be understood as a quantification of the speed of the dissolution process.

It is notable that, during mastication, solid foods typically reside in the mouth for as little as 30-60 seconds. For this reason solids which dissolve in the saliva on an equivalent timescale to the period between ingestion and swallowing will be able to provide a higher concentration of taste eliciting molecules or ions, as compared to foods which dissolve more slowly. A higher concentration of such molecules will correspond to an increased perception of a particular taste. Thus, relative to the equilibrium solubility of a solid food, the kinetic dissolution rate of the food that will have a greater influence on taste perception. Sodium chloride (i.e. NaCl or salt) is commonly used for seasoning, processing or preserving food products. Many foods contain solid crystals of pure NaCl, in which each sodium ion is surrounded by six chloride ions in what is termed a face centred cubic lattice. NaCl crystals are highly soluble in water (e.g. solubility of 360 g NaCl per litre of water at 30° C.) as well as having a high kinetic dissolution rate. These characteristics make NaCl a highly effective flavour provider. A recent study on the relationship between NaCl crystal morphology and the perception of saltiness showed that salt crystal morphology correlated well with dissolution rate. Notably, non-cubic and agglomerated crystals, such as Kosher and Maldon salts, were dissolved faster resulting in greater perceived maximum saltiness, which occurred in a shorter time period (M. Quilaqueo et al., Food Research International, 2015, 76; 675-681).

Although widely used in food products, diets with high levels of sodium intake are associated with an increased risk of hypertension and cardiovascular diseases. Indeed the World Health Organization (WHO) recommends that in order to prevent chronic diseases, the upper daily limit of sodium intake for an adult should be less than 5 g of NaCl per day. However, in the US and UK it is estimated that the average NaCl intake is 8.2-9.4 g/day, while in Asian countries an average intake of NaCl of greater than 12.0 g/day has been reported (Liem et al., Nutrients 2011; 3, 694-711). Therefore, there is a need for new compositions or formulations that enable levels of sodium chloride or sodium to be reduced in nutritional products.

Sodium chloride replacers such as potassium chloride, calcium chloride and magnesium sulphate have been used to replace or enhance salt taste in a number of food products. For example the NaCl replacement LO-SALT® comprises a mixture of sodium chloride, potassium chloride, whereas PANSALT® comprises a mixture of sodium chloride, potassium chloride and magnesium sulphate. WO 2014/167185 discloses a homogeneous co-crystallised salt product including an alkaline earth metal chloride component, an alkaline metal chloride component and an ammonium chloride component as a low sodium product. While compounds such as potassium chloride and alkaline earth metal salts do contribute a certain salty taste quality, they may also provide undesirable after tastes such as bitter, metallic and astringent tastes, which has limited their current use in food manufacturing.

Co-crystalline forms of sodium chloride have been reported in the literature. For example Rendle et al. describe the characterization of a glucose monohydrate/sodium chloride complex by X-ray diffraction methods (Journal of Forensic Science Society 1988, 28, 295-297). Further, Mathiesen et al. report the existence of two crystal structures of the complex alpha-D-glucose.NaCl.H₂O(2:1:1) (Acta Crystallographica 1998, A54, 338-347). Additionally, a sarcosine.NaCl.H₂O co-crystal was reported in 1924 (P. Pfeiffer et al., Neutralsalzverbindungen der Aminosäuren and Polypeptide IV., Hoppe-Seyler's Zeitschrift fur Physiologische Chemie 1924, 133, 22-61). However, the author reported that the crystalline material believed to comprise sarcosine and NaCl could only be obtained once in pure form. Further, due to the early date of this work the crystalline material could not be analysed by either powder or single crystal X-ray diffraction. Notably, the dissolution behaviour and taste profiles of the previously reported NaCl co-crystals comprising carbohydrate or sarcosine were not investigated or commented on.

Accordingly, there remains a need for new forms of sodium chloride that provide a palatable and enhanced salty taste.

### SUMMARY OF THE INVENTION

The present inventors have surprisingly found that sodium chloride provided in the form of amino acid.sodium chloride co-crystals exhibits improved dissolution behaviour relative to a physical mix of amino acid and sodium chloride. Furthermore, it was found that the amino acid.sodium chloride co-crystals were perceived as having an enhanced salty taste relative to a corresponding physical mix of amino acid and sodium chloride.

Thus, in a first aspect the present invention provides a nutritional composition comprising serine.sodium chloride co-crystals. The serine.sodium chloride co-crystals can comprise a 2:1 molar ratio of serine to sodium chloride. Serine may be present in D or L-configuration, or as a mixture such as a racemic mixture. Preferably, the serine has L-configuration. The serine.sodium chloride co-crystals may be non-hydrated. The present invention further provides a co-crystal of L-serine and sodium chloride having a 2:1 molar ratio of L-serine to sodium chloride.

In a further aspect, the present invention provides the use of a serine.sodium chloride co-crystal for the preparation or manufacture of nutritional composition, preferably wherein the nutritional composition is a food product, a functional food product, a nutritional supplement, a pet food product, a flavouring agent, condiment or salt replacer. The co-crystals may also be used as a flavouring agent, a salt substitute, a food preservative or for providing a salty flavour to a nutritional composition.

### DESCRIPTION OF THE FIGURES

FIG. 1 Dissolution kinetics. The change in refractive index (n) was measured by online-refractometry in water over the time period 0 to 50 seconds. 0.56 g of pure NaCl (triangle); 2.58 g of (L-serine)₂.sodium chloride co-crystals (diamond); a physical mixture of 2.02 g L-serine and 0.56 g NaCl (cross); and a 2.02 g of pure L-serine (star) were each added to 60 mL of water stirred (500 rpm) at room temperature. The particle size of the respective solids was standardized in the range 100-200 μm.

FIG. 2 Sensory evaluation of (L-serine)₂.sodium chloride co-crystals or a physical mixture of L-serine and NaCl. The taste profiles of tablets comprising 123.7 mg of (L-serine)₂.sodium co-crystals or 96.9 mg of L-serine and 26.8 mg of NaCl were evaluated by 11 trained panellists. Bars coloured black denote a significant difference in a particular taste/sensory characteristic. Unshaded bars denote that there is no significant difference in the characteristic. A positive number represents an increased sensory response of the co-crystal compared to the physical mixture.

FIG. 3 Crystal parameters and atomic position plots for single co-crystals of (L-serine)₂.sodium chloride (FIG. 3A); (D-serine)₂.sodium chloride (FIG. 3B); and sarcosine.sodium chloride.H₂O (FIG. 3C). Crystal structures were determined from single crystal X-ray diffraction data collected at a temperature of 182-185 K using X-rays with wavelength 1.54180 Å. Atomic position plots were generated using the checkCIF/PLATON programme (A.L.Spek, Acta Cryst. 2009, D65, 148-155).

### DETAILED DESCRIPTION OF THE INVENTION

The present invention relates to nutritional compositions comprising co-crystals of amino acids and sodium chloride. In one embodiment, the nutritional composition comprises serine.sodium chloride co-crystals. Preferably the serine.sodium chloride co-crystals have the stoichiometry (L-serine)₂.sodium chloride.

### Amino Acids

Amino acids are organic compounds comprising amine (—NH₂) and carboxylic acid (—COOH) functional groups and optionally a side chain. The side chain group may be aliphatic, acyclic, or aromatic, or may contain one or more hydroxyl groups, or one or more sulfur or other (e.g. metal) atoms. The amino acid functional groups may be attached at the alpha- (α-), beta- (β-), gamma- (γ-) or delta- (δ) etc. positions. Amino acids having both their amine and carboxylic acid groups attached to a first carbon are known as alpha (α) amino acids and may have the generic formula H₂NCHRCOOH, where R is an organic side-chain group. The side-chain group may be non-polar, polar, acidic, or basic.

Certain α-amino acids are biologically important as they can be incorporated into polypeptides or proteins. These amino acids are termed proteinogenic amino acids. In vivo polypeptide synthesis is catalysed by ribosomes in a process known as translation. Known proteinogenic α-amino acids include alanine, arginine, asparagine, aspartic acid, cysteine, glutamine, glutamic acid, glycine, histidine, isoleucine, leucine, lysine, methionine, N-formyl methionine, phenylalanine, proline, pyrrolysine, selenocysteine (in which the thiol sulfur atom of cysteine is replaced with selenium), serine, threonine, tryptophan, tyrosine, and valine. Serine is a preferred amino acid for forming co-crystals with sodium chloride in accordance with the present invention.

In one embodiment, the present invention provides nutritional compositions comprising serine.sodium chloride co-crystals. Serine has the molecular formula C₃H₇NO₃ and the chemical formula:

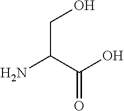

Many amino acids have at least one chiral centre. For instance, all proteinogenic amino acids, apart from glycine, have at least one chiral carbon. Solutions of chiral molecules have the ability to rotate plane polarised light, the direction and extent of which may be measured using e.g. a polarimeter. Depending on which particular stereoisomer of the chiral molecule is dominant in solution, the direction of rotation may either be to the right, dextrorotatory (D), or to the left, levorotatory (L). Accordingly, the L- and D- notation may be used to denote amino acid stereoisomers, i.e. L-amino acids and D-amino acids.

In some embodiments of the invention, the serine.sodium chloride co-crystals comprise D-serine. Alternatively, in other embodiments of the invention the serine.sodium chloride co-crystals comprise L-serine. Serine.sodium chloride co-crystals comprising both D- and L-serine, for example in a racemic mixture, are also envisaged. Preferably the serine.sodium chloride co-crystals comprise L-serine.

The amino acid.sodium chloride co-crystals disclosed herein may alternatively comprise a non-proteinogenic amino acid, an unnatural amino acid, a non-standard amino acid or a synthetic amino acid. Some non-proteinogenic amino acids occur naturally and/or are synthesised by cells, for example β-alanine, γ-aminobutyric acid (GABA) and 5-aminolevulinic.

Other non-standard amino acids include but are not limited to α-amino-n-butyric acid, norvaline, norleucine, homonorleucine, alloisolecuine, citrulline, homocitrulline, pipecolic acid, ornithine, allothreonine, homocysteine, homoserine, β-alanine, β-amino-n-butyric acid, β-aminoisobutyric acid, γ-aminobutyric acid, α-aminoisobutyric acid, isovaline, sarcosine, N-ethyl glycine, N-propyl glycine, N-isopropyl glycine, N-methyl alanine, N-ethyl alanine, N-ethyl β-alanine, isoserine, and α-hydroxy-γ-aminobutyric acid.

### Amino Acid.Sodium Chloride Co-Crystals

As used herein, the terms “crystal” or “crystalline material” refer to a solid material whose constituents are arranged in a regularly ordered pattern that is periodic in three dimensions.

The term “co-crystal” as used herein refers to a crystalline structure comprising at least two components in a defined stoichiometric ratio. The components may be, e.g., atoms, ions or molecules. The stoichiometric ratio of components in a co-crystal may be determined by X-ray diffraction. For example, the atomic arrangement of molecules and ions within a crystal lattice can be determined by single-crystal X-ray diffraction, or X-ray powder diffraction.

As used herein the term “amino acid.sodium chloride co-crystal” refers to a co-crystalline form comprising at least one amino acid molecule and sodium chloride in a defined stoichiometric molar ratio. For example an amino acid.sodium chloride co-crystal according to the present invention may be a serine.sodium chloride co-crystal.

Ionic salts, e.g. sodium chloride, are maintained in the solid state by Coulombic interactions, which determine their overall physico-chemical properties and general chemical behaviour. In contrast, amino acids are maintained in their solid state by Van-der-Waals interactions, hydrogen-bonding and Coulombic interactions. This difference in bonding is responsible for the different physical and chemical properties of pure amino acids and pure sodium chloride in their solid forms, e.g. differences in hardness or melting.

Amino acid.sodium chloride co-crystals (hydrated or non-hydrated) are characterised in that they are maintained in a solid, crystalline state by a combination of Coulombic interactions, Van-der-Waals interactions and hydrogen-bonding. Consequently, the solid-state behaviour of amino acid.sodium chloride co-crystals will differ to that of either of the constituent components alone. This principle will apply to a variety of co-crystalline combinations of amino acids with sodium chloride and is not limited to the specific co-crystals disclosed herein. Accordingly, the behaviours observed for individual co-crystalline systems may be applied more generally to a range of possible co-crystalline forms of amino acids in combination with sodium chloride.

The amino acid.sodium chloride co-crystals disclosed herein may comprise a stoichiometric molar ratio of amino acid to sodium chloride. For example the amino acid.sodium chloride co-crystals may comprise a molar ratio of amino acid to sodium chloride of 4:1-1:4, e.g. 4:1, 3:1, 2:1, 1:1, 1:2, 1:3, or 1:4. Preferably the amino acid.sodium chloride co-crystals comprise a stoichiometric molar ratio of amino acid to sodium chloride of 2:1 or 1.1.

In some embodiments of the present invention the amino acid.sodium chloride co-crystals are non-hydrated. Non-hydrated amino acid.sodium chloride co-crystals do not comprise stoichiometric amounts of water. Preferably, the serine.sodium chloride co-crystals of the present invention are non-hydrated.

The amino acid.sodium chloride co-crystals disclosed herein in accordance with any aspect or embodiment of the present invention may be substantially free of other forms of the amino acid.sodium chloride co-crystals. For example, the serine.sodium chloride co-crystals of the invention (e.g. as characterised by a specific XRPD or by single crystal data) are preferably substantially free of other forms of serine acid.sodium chloride crystals having different characteristic XRPD peaks or different single crystal data. By “substantially free” used herein, unless otherwise stated, it is meant that the amino acid.sodium chloride co-crystals of the present disclosure contains: about 10% (w/w) or less, about 5% (w/w) or less, about 2% (w/w) or less, about 1% (w/w) or less, about 0.5% (w/w) or less, or about 0.2% (w/w) or less of other forms of the amino acid.sodium chloride co-crystals. In other embodiments, the amino acid.sodium chloride co-crystals of the present invention contain from about 0.2% to about 10% (w/w), from about 0.2% to about 5% (w/w), from about 0.2% to about 2% (w/w) of other forms of the amino acid.sodium chloride co-crystals.

In a particular embodiment, the (L-serine)₂.sodium chloride co-crystal characterised by single crystal data having the following unit cell parameters: a=10.1±0.5 Å, b=6.7±0.5 Å, c=8.5±0.5 Å; and α=90.0°, β=91.1 ±0.5°, γ=90.0°, volume 575.9±1.0° Å is substantially free of other crystalline forms of (L-serine)₂.sodium chloride cocrystal. Preferably, the (L-serine)₂.sodium chloride co-crystal of the present invention is substantially free of serine.sodium chloride co-crystals such as serine.sodium chloride co-crystals having unit cell data: a=5.6116 Å, b=8.5685 Å, c=9.3480 Å; and α=90.0°, β=90°, γ=90.0, Volume 449.4775 Å.

Alternatively, or additionally, the amino acid.sodium chloride co-crystals disclosed herein may be substantially free of “free” sodium chloride and/or “free” amino acid, and preferably is substantially free of both sodium chloride and amino acid. “Free” in this context refers to the sodium chloride or amino acid not being part of the crystal lattice. For example, the sodium chloride or amino acid where present may be attributed to an incomplete crystallisation process, such that the amino acid and/or sodium chloride are not incorporated into the crystal lattice. By “substantially free” in this context, unless otherwise indicated, it is meant that the amino acid.sodium chloride co-crystals of the present disclosure contains: about 10% (w/w) or less, about 5% (w/w) or less, about 2% (w/w) or less, about 1% (w/w) or less, about 0.5% (w/w) or less, or about 0.2% (w/w) or less of the free amino acid and/or sodium chloride, or both. In other embodiments, the amino acid.sodium chloride co-crystals of any embodiment of the present invention contain from about 0.2% to about 10% (w/w), from about 0.2% to about 5% (w/w), from about 0.2% to about 2% (w/w) of the unbound amino acid and/or sodium chloride or both.

In one embodiment, the amino acid.sodium chloride co-crystals disclosed according to any embodiment discussed herein, particularly (L-serine)₂.sodium chloride co-crystals, (D-serine)₂.sodium chloride co-crystals, and especially (L-serine)₂.sodium chloride co-crystals, are substantially free (as defined above) of other forms of (L-serine)₂.sodium chloride co-crystals or other forms of (D-serine)₂.sodium chloride respectively, and/or are substantially free (as defined above) of free amino acid and/or substantially free (as defined above) of free sodium chloride.

Thus, in one embodiment of the invention there is provided a nutritional composition comprising serine.sodium chloride co-crystals, wherein the serine.sodium chloride co-crystals comprise serine to sodium chloride in a molar ratio of 2:1, wherein the serine has the L-configuration, and preferably wherein the crystal is non-hydrated.

In another embodiment the serine.sodium chloride co-crystals have the stoichiometry (L-serine)₂ .sodium chloride.

In one embodiment of the invention, there is provided a nutritional composition comprising serine.sodium chloride co-crystals, wherein the serine.sodium chloride co-crystals comprise a 2:1 molar ratio of serine to sodium chloride, and wherein the serine has the D-configuration, and preferably wherein the crystal is non-hydrated.

In another embodiment the serine.sodium chloride co-crystals have the stoichiometry (D-serine)₂ .sodium chloride.

Alternatively, in other embodiments of the invention, the amino acid.sodium chloride co-crystals are hydrated. In addition to amino acids and sodium chloride, hydrated amino acid.sodium chloride co-crystals comprise molecules of water in stoichiometric amounts. For example the amino acid.sodium chloride co-crystals may be hemihydrated, monohydrated, sesquihydrated, dihydrated, trihydrated, tetrahydrated, pentahydrated, hexahydrated, heptahydrated, octahydrated, nonahydrated, decahydrated, undecahydrated or dodecahydrated etc.

The amino acid.sodium chloride co-crystals of the present invention may be mixed with any suitable compound. For example, the amino acid.sodium chloride co-crystals of the present invention may be mixed with anti-caking agents, inorganic salts (e.g. ammonium chloride), metal salts (e.g. calcium chloride, potassium chloride, magnesium chloride, magnesium sulphate), amino acids, amino acid salts, carbohydrates, co-crystals of sodium chloride (e.g. co-crystals of sodium chloride with amino acids, co-crystals of sodium chloride with carbohydrates, and mixtures thereof), sea salt, fortified salt, salt microspheres, salt replacers, LO-SALT® (containing potassium chloride, sodium chloride, and anticaking agents—magnesium carbonate and hexacyanoferrate salts), SODA-LO® (sodium microspheres), PANSALT® (containing sodium chloride, potassium chloride, magnesium sulphate, lysine, anticaking agent and potassium iodide), SMART SALT® (containing magnesium chloride, calcium chloride, potassium chloride and ammonium chloride or mixtures thereof. as well as salt-taste enhancers or positive allosteric modulator (PAM)s of salt taste receptors as illustrated in WO2012/121273A1, WO2011/130707A2, WO2011/010748 as well as magnesium glutamate, gamma-polyglutamic acid, methionol.

The amino acid.sodium chloride co-crystals of the present invention may comprise a single amino acid type. Such amino acid.sodium chloride co-crystals, for example serine.sodium chloride co-crystals may be mixed with co-crystals of sodium chloride with other amino acids in order to provide mixtures of amino acid.sodium chloride co-crystals comprising different amino acids, for example mixtures of two, three, four, five or more different amino acid.sodium chloride co-crystals. Further, the present invention encompasses the preparation of amino acid.sodium chloride co-crystals comprising a number of different amino acids, for example amino acid.sodium chloride co-crystals comprising two, three, four, five or more different amino acids.

### Preparation of Amino Acid.Sodium Chloride Co-Crystals

Amino acid.sodium chloride co-crystals (for example serine.sodium chloride co-crystals) may be obtained by co-crystallization, by seeding a supersaturated solution with a seeding crystal, by ultrasound-assisted crystallization, by mechanochemical synthesis, by moisture sorption, by ball milling the constituents of the co-crystal, by atomization or spray-drying solutions of an amino acid and sodium chloride (for example serine and sodium chloride), by twin-screw extrusion of an amino acid (for example serine)with sodium chloride, by freeze-drying a solution of an amino acid (for example serine) and sodium chloride, or by roller-compaction of an amino acid (for example serine) with sodium chloride. In general, pure amino acids (either in their zwitterionic or hydrated form or as a nutritionally acceptable salt, e.g. a hydrochloric salt) and sodium chloride are required to produce co-crystals.

In particular, amino acid.sodium chloride co-crystals may be obtained by conducting co-crystallization in a solution or slurry comprising the amino acid and sodium chloride. For example, serine.sodium chloride co-crystals may be obtained by conducting co-crystallization in a solution or slurry comprising serine and sodium chloride.

Alternatively, amino acid.sodium chloride co-crystals (for example serine.sodium chloride co-crystals) may be prepared by grinding, e.g. manually with mortar and pestle, or by milling, for example in a ball mill or a vibratory mill. Optionally, liquid-assisted grinding may be performed to produce amino acid.sodium chloride co-crystals (for example serine.sodium chloride co-crystals). Alternatively, the co-crystals of the present invention may also be prepared by simple mechanical mixing and subsequent storage at a certain relative humidity.

To produce co-crystals via grinding both starting materials need to display a solid, powdery form before ball-milling (crystalline or amorphous). The starting materials must be pure compounds, either in their zwitterionic or hydrated form or as a nutritionally acceptable salt, e.g. a hydrochloric salt and no other materials should be present except silica. During ball-milling the temperature should not rise above the melting point of either the individual pure compounds or the co-crystal. Also, grinding conditions need to be adapted, so that the mixture remains flowable as a powder during mechanical treatment. This can be achieved by a lower mechanical impact with extended reaction times or adaptation of the mechanical force applied via the number and size of balls used in a ball-milling process. For the production of a co-crystal, both materials should be chemically inert to each other in order to avoid chemical reactions or degradation. Grinding times and humidity levels can be adapted in order to achieve a fast conversion into the co-crystalline phase, so that processing times are short. This can be realized by a grinding kinetic, e.g. milling the starting materials for a specific duration under fixed conditions and verifying via X-ray powder diffraction is the desired conversion level is achieved.

Amino acid.sodium chloride co-crystals (for example serine.sodium chloride co-crystals) may be prepared by cooling a molten mixture, or a saturated solution of the two components (for example the two pure components), i.e. a molten mixture or saturated solution of amino acid (e.g. serine) and sodium chloride, resulting in co-crystal formation by precipitation.

Amino acid.sodium chloride co-crystals (for example serine.sodium chloride co-crystals) may preferably be prepared by adding an antisolvent to a saturated solution of the two components, i.e. an amino acid (such as serine) and sodium chloride, resulting in co-crystal formation by precipitation, as the antisolvent will generate supersaturation and cause nucleation of the co-crystalline phase.

Preferably, the added antisolvent is a food-grade solvent. Preferred examples of food-grade solvents include, e.g. water, ethanol, isopropanol, propanol, propylene glycol, acetone, glycerol, triacetin, triethylcitrate, acetic acid or ethyl acetate and mixtures thereof.

Optionally, preparation of amino acid.sodium chloride co-crystals (for example serine.sodium chloride co-crystals) by cooling of a molten mixture or a saturated solution of amino acid (such as serine) and sodium chloride may require seeding with a seeding co-crystal.

In the present context, “seeding” means the use of a small quantity of a co-crystal, i.e. a seeding co-crystal, from which larger co-crystals of the identical crystalline phase are grown. In some processes, seeding can be used to avoid spontaneous nucleation of undesired phases and therefore allows for a controlled production process of the desired material.

The seeding crystal may be prepared by co-crystallizing the amino acid (such as serine) and sodium chloride by cooling a molten mixture or a saturated solution of the amino acid (such as serine) and sodium chloride.

Optionally a saturated solution of amino acid (e.g. serine) and sodium chloride can be subjected to slow evaporation to form the amino acid.sodium chloride co-crystal (for example serine.sodium chloride co-crystal).

It should be understood that specific conditions are required for the formation of co-crystals, and not all amino acids will form co-crystals with sodium chloride. The inventors tried forming co-crystals of sodium chloride with a range of amino acids by crystallization techniques and mechanochemical approaches, but co-crystal formation was only observed in the case of serine (D and L configurations) and sarcosine. When assessing a new amino acid or new preparation conditions, analysis of the obtained product is necessary to determine whether or not co-crystals have been produced.

### Characterisation of Amino Acid.Sodium Chloride Co-Crystals

### X-ray Powder Diffraction (XRPD)

One technique that may be used to characterise the composition of crystalline materials is X-ray Powder Diffraction (XRPD). To analyse a sample, a capillary containing powdered crystalline material is placed in a beam of monochromatic X-rays, thereby generating a number of diffracted X-ray beams, which are collected on a suitable detector. A crystalline material will provide a diffraction pattern characterised by a number of sharp peaks. In contrast, the diffraction patterns obtained from amorphous materials will be broader and less well defined.

As used herein, unless indicated otherwise, XRPD peaks are reported in degrees two theta ±0.2 degrees two theta, measured using CuKa radiation (wavelength 1.54180 Å).

The skilled person will recognise that any other suitable techniques known in the art may be used to characterise the amino acid.sodium chloride co-crystals disclosed herein. For example, single crystal X-ray diffraction, such as discussed below, can be used.

### Single Crystal X-Ray Diffraction

Crystalline materials may also be characterised by single crystal X-ray diffraction. In this technique a single sample crystal is rotated in a coherent beam of monochromatic X-rays, thereby generating pattern of diffracted X-rays, which is recorded on a suitable detector (e.g. photographic film, CCD or direct electron detector). From the diffraction pattern, crystallographic parameters (e.g. unit cell, symmetry, crystal system and space group) are calculated, which are then used to determine the arrangement of atoms, molecules or ions making up the crystal lattice.

The skilled person will recognise that any other suitable technique known in the art may be used to characterise the crystal parameters and molecular arrangement of the amino acid.sodium chloride co-crystals disclosed herein.

The unit cell of a crystal may be understood as the smallest unit of volume that contains all the structural information necessary to re-create the macroscopic structure of the crystal lattice by translation. Conventionally the unit cell is defined by three dimensions (a, b and c) and the angles between them (α, β, and γ). A crystal may also be described in terms of its symmetry, for example by its crystal system, crystal family lattice system, space groups, Bravais lattices, or point groups. For example there are seven crystal systems (triclinic, monoclinic, orthorhombic, tetragonal, trigonal, hexagonal and cubic), seven lattice systems, 14 Bravais lattices, 32 point groups and 230 space groups.

The present inventors have synthesised and characterised three different amino acid.sodium chloride co-crystals by single crystal X-ray diffraction. The respective crystal parameters for co-crystals having the stoichiometry: (L-serine)₂.sodium chloride; (D-serine)₂.sodium chloride; and sarcosine.sodium chloride.H₂O are provided in Table 1 (Example 8).

Thus in one embodiment of the present invention there is provided a co-crystalline form of L-serine and sodium chloride having a 2:1 molar ratio of L-serine to sodium chloride.

Preferably the co-crystalline form of L-serine and sodium chloride is non-hydrated.

In a preferred embodiment of the present invention the co-crystalline form of L-serine and sodium chloride has the stoichiometry (L-serine)₂.sodium chloride.

In yet another embodiment there is provided a co-crystalline form of (D-serine)₂.sodium chloride.

The (L-serine)₂.sodium chloride or (D-serine)₂.sodium chloride co-crystals may each be characterised by the following unit cell parameters: a=10.1±0.5 Å, b=6.7±0.5 Å, c=8.5±0.5 Å; and α=90.0°, β=91.1±0.5°, γ=90.0°, preferably having cell volume 575.9±0.5 Å. The (L-serine)₂.sodium chloride or (D-serine)₂.sodium chloride co-crystals may additionally be characterised by the space group C121.

Preferably the (L-serine)₂.sodium chloride or (D-serine)₂.sodium chloride co-crystals crystals are monoclinic.

In the monoclinic crystal system, vectors a, b and c have unequal lengths (i.e. a≠b≠c) and form a rectangular prism with a parallelogram as its base. Accordingly, two vectors (a and b) are perpendicular (meet at right angles), while the third vector meets the other two at an angle other than 90°, i.e. α, γ=90° and β≠90°.

### Dissolution Kinetics

“Dissolution” as used herein means the process by which a solute forms a homogeneous solution in a solvent, e.g. water, ethanol, glycerol, propylene glycol, milk, coffee, tea, juice or saliva.

As used herein the term “dissolution kinetics” is defined as the rate of the physico-chemical process of dissolution, i.e. the speed of dissolution.

The rate of dissolution of a solid in a liquid medium is related to the properties of both the solid and the medium. This relationship may be expressed by the Noyes-Whitney equation, as follows:

$$\frac{dW}{dt} = \frac{DA ( {C}_{s} - C )}{L}$$

Where dW/dt is the rate of dissolution; A is the surface area of the solid; C is the concentration of the solid in the liquid medium; Cₛ is the concentration of the solid in the diffusion layer surrounding the solid; D is the diffusion coefficient; and L is the diffusion layer thickness.

The rate of dissolution of a solid in a liquid may be measured by refractometry. A refractometer measures the extent to which light is refracted when it moves from air into a sample, thereby allowing the refractive index (n) of the sample to be measured. As increasing amounts of a solute dissolve in a liquid medium, the refractive index of the solution increases. Accordingly, by monitoring the change in refractive index over time, the kinetic rate of dissolution of a solid can be determined. So that independent measurements of dissolution rate can be compared, the refractive index values may be normalised by expression as a percentage of the maximal value recorded in a particular experiment.

A person of ordinary skill in the art, will recognise that any other suitable technique may be used to determine the rate of dissolution of an amino acid.sodium chloride co-crystal, e.g. by using density meter.

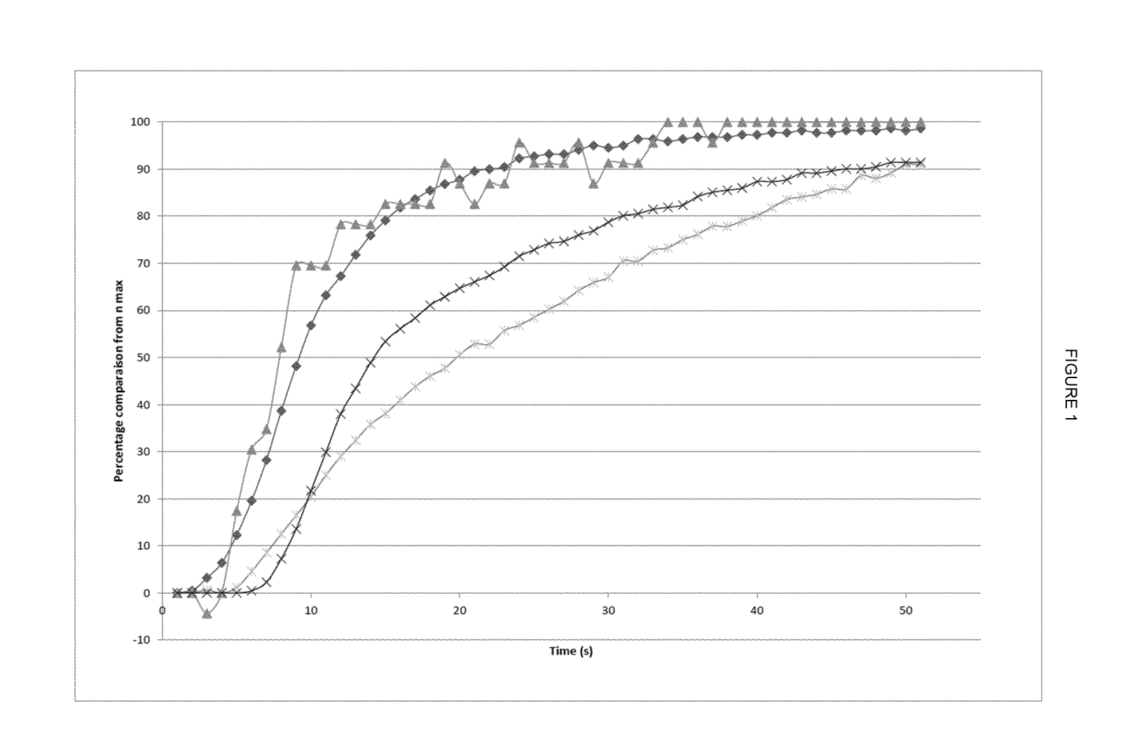

The present inventors propose that the advantageous salty taste provided by the amino acid.sodium chloride co-crystals disclosed herein results from the enhanced dissolution behaviour of the co-crystals. In particular the rate of dissolution of (L-serine)₂.sodium chloride crystals was found to be similar to that of pure sodium chloride and significantly superior to that of an equivalent physical mix of L-serine and sodium chloride, as depicted in FIG. 1. Indeed both (L-serine)₂.sodium chloride crystals and pure sodium chloride reached 50% dissolution in less than 10 seconds.

Accordingly, the present invention also provides nutritional compositions comprising amino acid.sodium chloride co-crystals (for example serine.sodium chloride co-crystals) which may be characterised in that 50% dissolution of the co-crystal occurs in less than: about 15 s, about 14 s, about 13 s, about 12 s, about 11 s, about 10 s, or about 9 s. The present invention also provides nutritional composition comprising amino acid.sodium chloride co-crystals (for example serine.sodium chloride co-crystals), wherein the amino acid.sodium chloride co-crystals may be characterised in that 70% dissolution of the co-crystal occurs in less than about 20 s, less than about 18 seconds, less than about 15 seconds, or less than about 14 seconds. The present invention also provides nutritional composition comprising amino acid.sodium chloride co-crystals (for example serine.sodium chloride co-crystals) which may be alternatively or additionally characterised in that 90% dissolution of the co-crystal occurs in less than about 30 s, less than about 25 seconds, less than about 28 seconds, less than about 25 or less than about 24 seconds.

### Nutritional Compositions

As used herein, the term “nutritional composition” means a composition which nourishes a subject. The nutritional composition is usually to be taken orally, intragastrically or intravenously. Preferably, the nutritional compositions of the present invention are to be taken orally, i.e. oral nutritional compositions.

The nutritional compositions disclosed herein may comprise any of the amino acid.sodium chloride co-crystals disclosed herein. In particular present invention provides nutritional compositions comprising serine.sodium chloride co-crystals.

Nutritional compositions, as used herein, may include any number of optional ingredients in addition to the amino acid.sodium chloride co-crystals. Such additional ingredients include, but are not limited to, conventional food additives (synthetic or natural), for example one or more acidulants, additional thickeners, buffers or agents for pH adjustment, chelating agents, colorants, emulsifiers, excipients, flavouring agents, minerals, amino acids, osmotic agents, pharmaceutically acceptable carriers, preservatives, stabilizers, sugar, sweeteners, texturizers, and/or vitamins. The optional ingredients can be added in any suitable amount.

The nutritional composition may be in the form of powder, tablets, capsules, or pastilles, for example. The composition may further contain protective hydrocolloids (such as gums, proteins, modified starches), binders, film forming agents, encapsulating agents/materials, wall/shell materials, matrix compounds, coatings, emulsifiers, surface active agents, solubilizing agents (oils, fats, waxes, lecithins etc.), adsorbents, carriers, fillers, co-compounds, dispersing agents, wetting agents, processing aids (solvents), flowing agents, taste masking agents, weighting agents, jellifying agents and gel forming agents.

The nutritional composition may contain vitamins and minerals understood to be essential in the daily diet and in nutritionally significant amounts. Minimum requirements have been established for certain vitamins and minerals. Examples of minerals, vitamins and other nutrients optionally present in the composition include vitamin A, vitamin B1, vitamin B2, vitamin B6, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chlorine, potassium, sodium, selenium, chromium, molybdenum, taurine, and L-carnitine. Minerals are usually added in salt form. The presence and amounts of specific minerals and other vitamins will vary depending on the intended population.

The nutritional composition may also contain other substances which may have a beneficial effect such as lactoferrin, nucleotides, nucleosides, gangliosides, polyamines, monopeptides, dipeptides and the like.

The nutritional composition may be in the form of a nutritional supplement. A nutritional supplement refers to a product which is intended to supplement the general diet of a subject.

The nutritional composition may be in the form of a complete nutritional product. A complete nutritional product refers to a product which is intended to be the sole item or meal or diet consumed by a subject. As such, a complete nutritional product may contain sufficient types and levels of macronutrients (proteins, fats and carbohydrates, e.g. starches) to be sufficient to be a sole source of nutrition for the subject to which it is being administered.

The nutritional composition may be inserted or mixed into a food substance. The nutritional composition may be in the form of a food stuff, for example a human food stuff.

Generally, the nutritional composition as used herein may be a food product, a functional food product, a frozen food, a ready-meal, a microwaveable product, an individually portioned product, a dairy product, a confectionery product, a culinary product, an instant food product for providing a beverage, a nutritional supplement, or a pet food product.

A food product in the present context means a substance that serves as food or can be prepared as food, i.e. a substance that can be metabolized by an organism resulting in energy and/or tissue.

Preferably, the food product is a pizza, a savoury turnover, a bread, a cookie, a pasta, a gluten-free pasta, a gluten-free dough, a dough, a pizza dough, a chilled dough product, a frozen dough product, a mayonnaise, a spread, a thickener, a pretzel, a snack product, a potato chip, a tortilla, a bouillon cube, a cooking aid, a tastemaker, a gellified concentrated bouillon, an instant soup, a topping, a salt replacer, a seasoning mix, a flavouring, a flavour mix, a fortifying mix, or a mineral mix.

In the context of the present invention, a functional food product is a food product providing an additional health-promoting or disease-preventing function to a subject. Any kind of known biologically-active compound may be added to the food product of the invention in order to provide additional health benefits.

The term dairy product, as used herein, refers to food products derived from animals such as cows, goats, sheep, yaks, horses, camels, and other mammals. Examples of dairy products include but are not limited to milk powder, skimmed milk powder, condensed milk, cheese, cheese powder, ice cream, yoghurt, cream, cream cheese, butter, spreads, and confectionery products, e.g. chocolate. Preferably, the dairy product is selected from a milk product, a milk powder, a cheese, a cream cheese, a cheese powder, a butter or a spread.

In the present context, a nutritional supplement describes a nutritional composition which may be provided in addition to a regular diet to provide nutrients (macronutrients or micronutrients) or dietary fibers, e.g. micronutrients like certain vitamins, minerals, e.g. macronutrients like fatty acids, amino acids, carbohydrates, protein etc.

In the present context, a pet food product may be understood as a nutritional product that is intended for consumption by pets. A pet or companion animal is an animal selected from dogs, cats, birds, fish, rodents such as mice, rats, and guinea pigs, rabbits, etc.

The amino acid.sodium chloride co-crystals disclosed herein may be mixed into a food product or be applied on the outside of the food product without substantially intruding into the food product, e.g. granules of an amino acid.sodium chloride co-crystal may be applied on the surface of a pizza, a savoury turnover, a salted snack, a pretzel, a chip, crisps, a vegetable chip, sweet potato chips, wafers, a nacho, a taco, salted nuts, a cracker, an extruded snack, salted puffs, peanuts, popcorn, salted cookies, French fries, baked potatoes, bread, a pasta, or as a seasoning/topping.

In the field of food science, water activity (aw) is understood as the partial vapour pressure of water in a substance divided by the standard state partial vapour pressure of water. The standard state is the partial vapour pressure of pure water at the same temperature. a_{w}=p/p₀, where p is the vapour pressure of water in the substance, and p₀ is the vapour pressure of pure water at the same temperature.

The amino acid.sodium chloride co-crystals disclosed herein (for example serine.sodium chloride co-crystals) may be applied to any nutritional composition or food product that contains sufficiently low humidity to prevent the complete dissolution of the co-crystal prior to contact of the co-crystal with the saliva of a consumer. In particular, it is preferred that the nutritional composition exhibits water activity (a_{w}) not suitable for dissolving the amino acid.sodium chloride co-crystals (for example serine.sodium chloride co-crystals) disclosed herein.

For example the nutritional composition or food product may have an a_{w} of less than about 0.90, less than about 0.85, less than about 0.80, less than about 0.75, less than about 0.70, less than about 0.65, less than about 0.60, less than about 0.50, less than about 0.55, or less than about 0.40.

Nutritional compositions may be prepared by the addition of adding further nutrients, e.g. fats, proteins, starches, vitamins, minerals, carbohydrates, polyphenols, peptides to the amino acid.sodium chloride. Preferably the nutritional composition further comprises a nutrient selected from the group consisting of fat, protein, vitamin, mineral and amino acid.

Preferably, the nutritional compositions disclosed herein comprise an amount of amino acid.sodium chloride salt co-crystals (for example serine.sodium chloride co-crystals) sufficient to provide the consumer with a sufficient amount of amino acid (for example serine) and/or sodium chloride and/or a palatable salty taste.

Thus, the nutritional compositions disclosed herein may comprise amino acid.sodium chloride co-crystals (for example serine.sodium chloride co-crystals) according to any aspect or embodiment of the present invention in a concentration of 0.01-100 wt % based on the total weight of the composition, 0.01-99 wt % based on the total weight of the composition, 0.01-70 wt % based on the total weight of the composition, 0.01-60 wt % based on the total weight of the composition, 0.01-50 wt % based on the total weight of the composition, 0.01-40 wt % based on the total weight of the composition, 0.01-20 wt % based on the total weight of the composition, 0.01-10 wt % based on the total weight of the composition, 0.01-5 wt % based on the total weight of the composition, 0.01-2 wt % based on the total weight of the composition, 0.01-1 wt % based on the total weight of the composition. It will be appreciated that the concentration required is dependent on the nutritional composition. For example, as a salt replacer or a flavouring agent such as a bouillon powder or stock cube, the composition may comprise >10 wt %, >20 wt %, >30 wt %, >30, >50 wt %, >60 wt %, >70 wt %, >80 wt %, >90 wt % of the co-crystals of the invention (for example serine.sodium chloride co-crystals) based on the total weight of the composition. As a flavouring agent in a food product, the composition may comprise 0.01-10 wt %, 0.01-5 wt %, 0.01-2 wt % or 0.01-1 wt % of the co-crystals of the present invention (for example serine.sodium chloride co-crystals), based on the total weight of the composition.

Also disclosed herein are nutritional compositions comprising any of the amino acid.sodium chloride co-crystals of the invention (for example serine.sodium chloride co-crystals) in a concentration of 10-50 wt % based on the total weight of the composition, more preferably in a concentration of 10-20 wt % based on the total weight of the composition.

In one embodiment there is provided a nutritional composition comprising the serine.sodium chloride co-crystals of the invention in a concentration of 0.01-10 wt % based on the total weight of the composition, preferably in a concentration of 0.1-5 wt % based on the total weight of the composition.

### Use of Amino Acid.Sodium Chloride Co-Crystals

The present inventors have synthesised and characterised amino acid.sodium chloride co-crystals that provide an enhanced salty flavour when consumed. Accordingly, the present invention also provides the use of amino acid.sodium chloride co-crystals (for example serine.sodium chloride co-crystals) for the preparation or manufacture of a nutritional composition, as a flavouring agent, as a salt substitute or for providing a salty taste to a nutritional composition.

In the context of the present invention, a salty taste is a taste that is produced by the presence of sodium ions. For example a salty taste may be detected and transduced via the permeation of sodium ions into Type 1 taste receptor cells, as mediated by the ENaC.

In one embodiment, the present invention provides the use of a serine.sodium chloride co-crystal of the invention:
(i) for the preparation or manufacture of a nutritional composition; or
(ii) for providing a salty flavour to a nutritional composition

The nutritional composition may be any nutritional composition described herein.

Preferably the nutritional composition is selected from the group consisting of a food product, a functional food product, a frozen food product, a dairy product, a microwaveable food product, a confectionery product, a culinary product, a nutritional supplement, or a pet food product.

Preferably the food product is a pizza, a savoury turnover, a bread, a cookie, a chocolate bar, a caramel sauce, a filling, a candy, a frozen pizza, pasta, gluten-free pasta, a dough, a gluten-free dough, a frozen dough, a chilled dough, a bouillon cube, a gellified concentrated bouillon, an instant soup, a ready-meal, a snack, a culinary aid, a mayonnaise, a spread, a thickener, a tastemaker, a pretzel, a potato chip, a French fries, a tortilla, a cracker, a rice cracker, a nut, a topping, a seasoning, a flavouring, a seasoning mix, a salt replacer, a table salt, a sea salt, a fortifying mix, and a mineral mix.

Various preferred features and embodiments of the present invention will now be described by way of non-limiting examples.

The practice of the present invention will employ, unless otherwise indicated, conventional techniques of chemistry, crystallography, food science, nutrition science and related fields, which are within the capabilities of a person of ordinary skill in the art. Such techniques are explained in the literature.

### EXAMPLES

### Example 1

### Synthesis of (L-Serine)₂.Sodium Chloride Seed Co-Crystals

In a 250 mL glass reactor equipped with a magnetic stirrer and a water bath, 30.0 g of sodium chloride and 53.7 g of L-serine were added to 79 mL water at 25° C. (200 rpm). The water bath was set up to 80° C. and the mixture was kept at 58° C. for period of 5 hours. A colourless and homogeneous solution was obtained, after which the temperature was set to 20° C., which allowed for the spontaneous formation of crystals. The temperature was maintained to 20° C. and the crystal growth was allowed to continue for 100 minutes while stirring at 150 rpm. Subsequently, stirring was halted and the suspension was filtered over a glass frit under reduced pressure (Borosilicat glass: 3.3; Porosity: 2; 600 mPa; Büchi Vacuum Pump V-700). The isolated crystals were washed with 10 mL of cold water at room temperature. The solid product was dried at 40° C. under vacuum for 2 hours (Rotavap R-210 Büchi; 12 mPa). The crystalline material was stored in tightly closed aluminium bags at ambient temperature.

24.3 g of co-crystalline (L-serine)₂.sodium chloride was obtained as a white powder (yield: 35%) and used as seeding crystals. The identity and phase purity of the obtained material was confirmed by powder X-ray diffraction methods and by comparison with a reference diffraction pattern previously determined from single crystal X-ray diffraction data.

### Example 2

### Synthesis of (L-Serine)₂.Sodium Chloride Co-Crystals by Direct Crystallisation

529 mL of water was placed at room temperature (Tₛₑₜ=25° C.) in a 1.2 L thermostatted glass reactor equipped with mechanical bottom stirrer (IKA® 1000 reactor), internal temperature control and a water condenser. While stirring (80 rpm), 200 g of sodium chloride and 358 g of L-serine were added over a period of 10 minutes. The temperature was then set to 75° C. After 180 minutes a colourless and homogeneous solution was obtained. Subsequently the temperature was set to 38° C. and the solution slowly cooled within 30 minutes. At this point, 100 mg of seeding crystals (see Example 1) were carefully added to the solution and the stirring rate was reduced to 30 rpm. Crystallization occurred within the next 50 minutes (formation of a suspension). Then, the temperature was set to 30° C. for 15 hours. In total, crystallization took 15 hours and 50 minutes from the addition of the seeding crystals. Finally, filtration, washing, drying and storage steps were performed in the same manner as described in Example 1. 93 g of the co-crystalline (L-serine)₂.sodium chloride was obtained as a white powder (yield: 21%).

### Example 3

### Mechanochemical Synthesis of (L-Serine)₂.Sodium Chloride Co-Crystals

1.79 g L-serine (17.0 mmol), 1.00 g Sodium Chloride (17.0 mmol) and 154 mg Milli-Q Water (8.5 mmol) were placed in a Retsch MM400 vibratory ball mill and ball-milled at room temperature at a frequency of 15 Hz with one INOX steel ball (diameter 15 mm) for 30 minutes to give the co-crystalline material.

### Example 4

### Synthesis of (L-Serine)₂.Sodium Chloride Co-Crystals by Moisture Sorption

1.79 g L-serine (17.0 mmol), 1.00 g sodium chloride (17.0 mmol) and 154 mg Milli-Q Water (8.5 mmol) were placed in a desiccator at room temperature with a fixed relative humidity of 52.9% RH (ensured by the presence of a saturated solution of Mg(NO₃)₂.6H₂O) for 1 week to give the co-crystalline material.

### Example 5

### Mechanochemical Synthesis of (D-Serine)₂.Sodium Chloride Co-Crystals

1.79 g D-serine (17.0 mmol), 1.00 g sodium chloride (17.0 mmol) and 154 mg Milli-Q Water (8.5 mmol) were placed in a Retsch MM400 vibratory ball mill and ball-milled at room temperature at a frequency of 15 Hz with one INOX steel ball (diameter 15 mm) for one hour to give the co-crystalline material. The same approach was also successful when no water was added to the D-serine and sodium chloride. Using molar ratios of 2:1 or 1:2 of the starting materials also gave the co-crystalline phase (no water added).

### Example 6

### Synthesis of (D-Serine)₂.Sodium Chloride Co-Crystals by Direct Evaporation

In a test tube, 1.79 g D-serine (17.0 mmol) and 1.00 g Sodium Chloride (17.0 mmol) were dissolved in 3 mL of Milli-Q Water. The water was evaporated slowly over a period of one day to give crystals, which were suitable for single crystal X-ray diffraction analysis. This analysis demonstrated the successful formation of the co-crystalline phase, which was determined to consist of (D-serine)₂.sodium chloride co-crystals.

### Example 7

### Synthesis and Characterisation of Sarcosine.Sodium Chloride.H₂O Co-Crystals

### Mechanochemical Synthesis

Following a mechanochemical synthesis of a co-crystalline material from sarcosine and sodium chloride (no water added) in molar ratios of 2:1 (1.49 g:0.49 g), 1:1 (1.49 g:0.98 g) and 1:2 (1.49 g:1.96 g), using a vibratory ball-mill (5 steel balls with a diameter of 15 mm, 20 Hz frequency, for 30 minutes) novel XRPD peaks could be detected for all three molar ratios of sarcosine to sodium chloride that were tested. Identical peaks were observed for the same three ratios supplemented with an additional of 0.5 molar equivalents of water (0.152 mL), i.e. ratios of sarcosine to sodium chloride to water of 2:1:0.5, 1:1:0.5 and 1:2:0.5. The XRPD peaks observed for the co-crystalline material formed in the presence of water were more intense. Although it is clear that a new crystalline phase had been generated, XRPD analysis also revealed that this material still contained unreacted starting materials, i.e. pure sodium chloride and pure sarcosine.

Crystallization from Solution

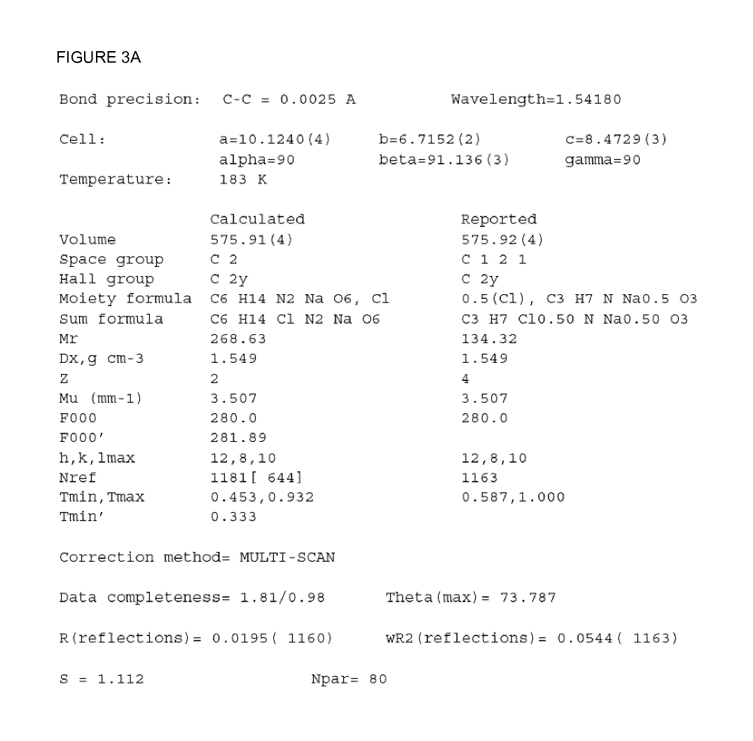

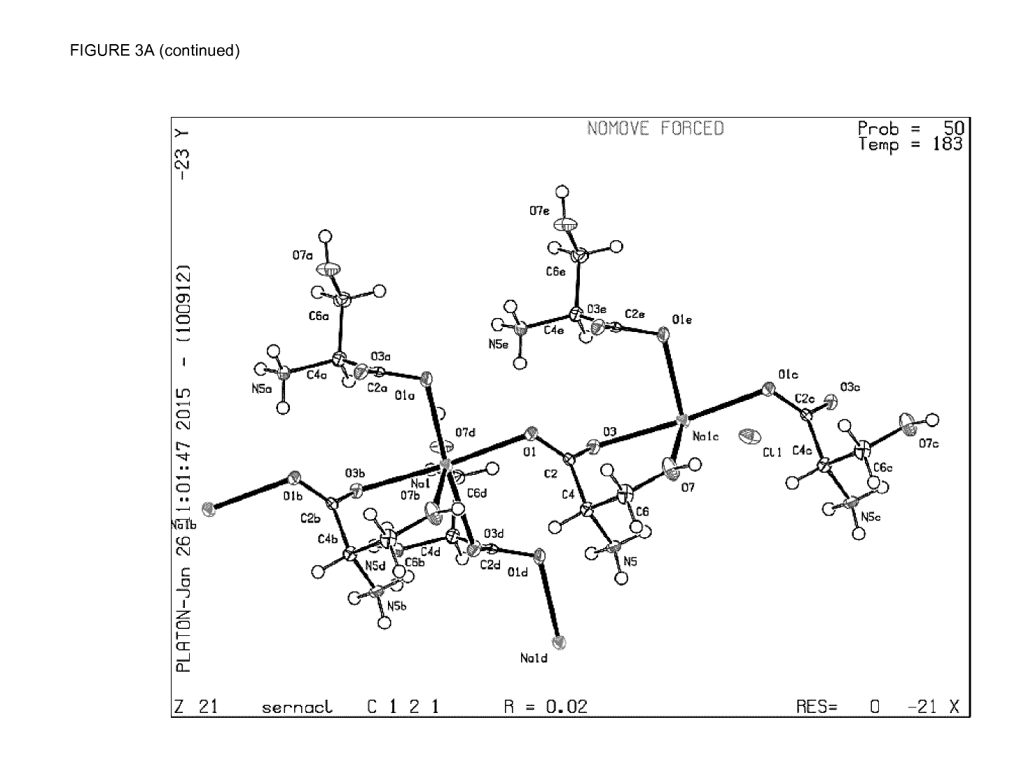

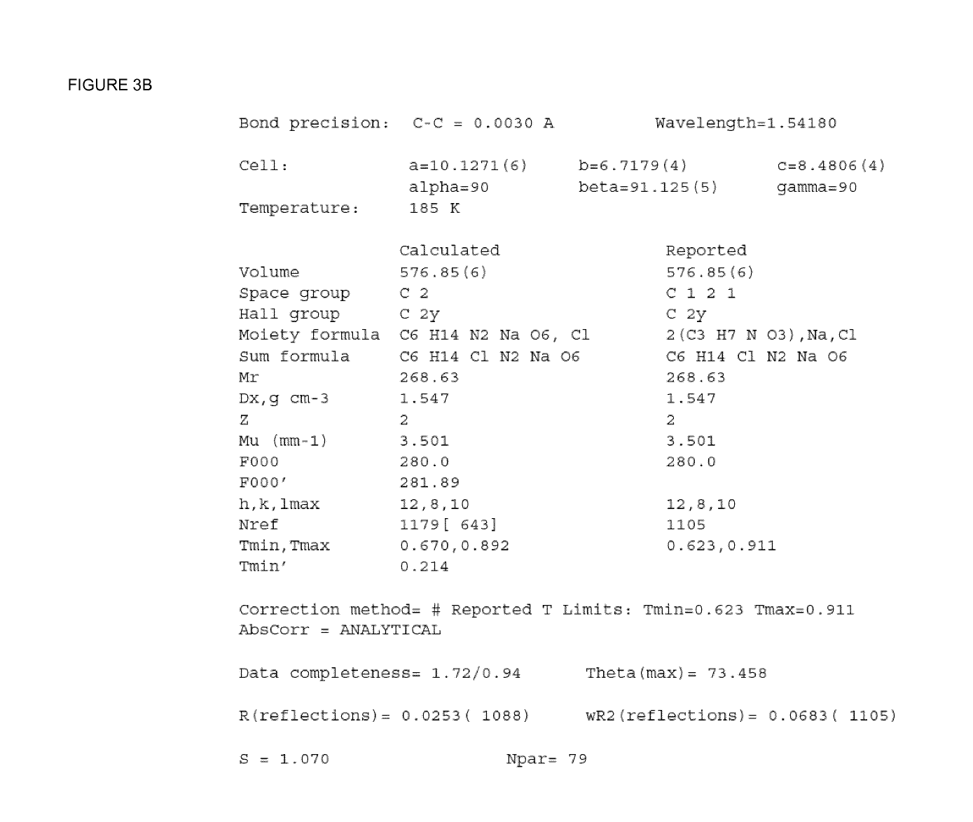

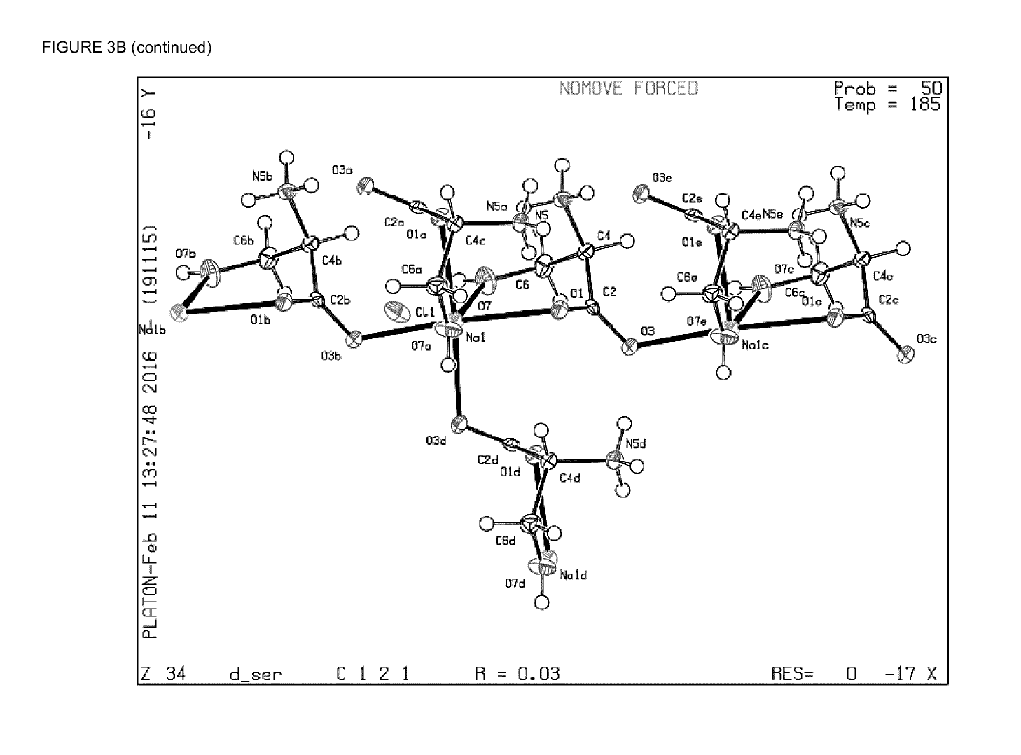

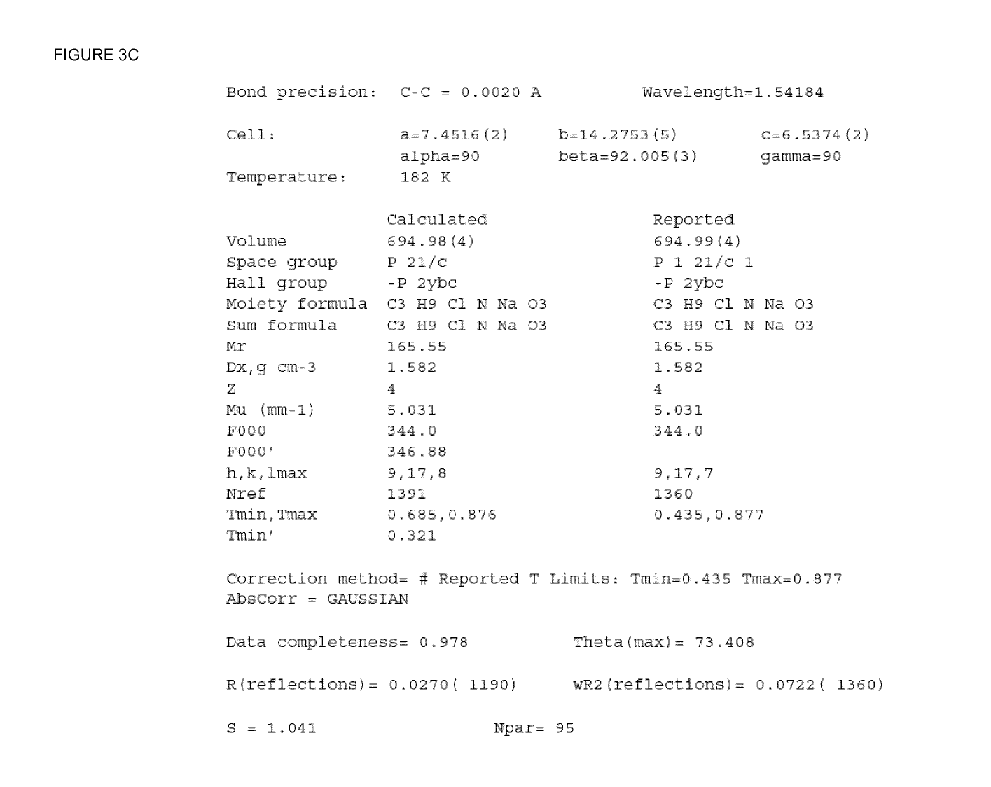

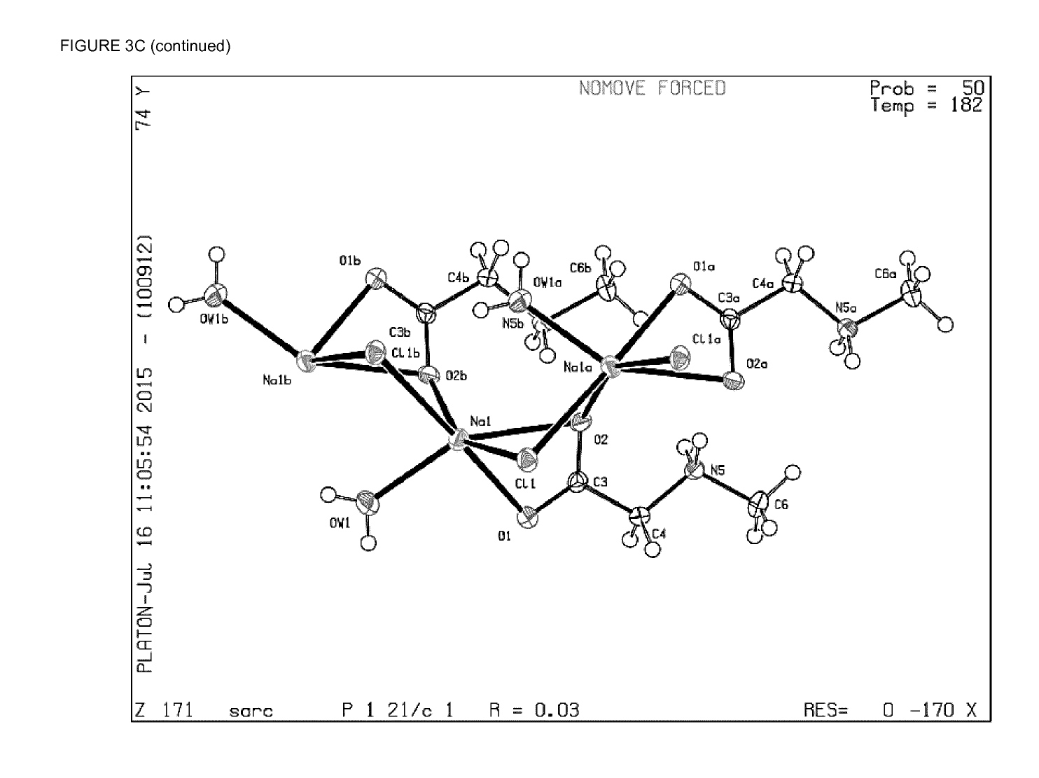

Crystallization by evaporation of an aqueous, saturated solution containing sarcosine and sodium chloride in molar ratios of 2:1 (3.00 g:0.98 g), 1:2 (2.97 g:3.92 g) and 1:1 (2.97 g:1.96 g) at ambient temperature. It was observed that crystals obtained from solutions having molar ratios of 1:2 and 1:1 of sarcosine to sodium chloride, contained only crystalline NaCl. However, solutions prepared with a molar ratio of 2:1 of sarcosine to sodium chloride yielded a crystalline phase corresponding to sarcosine.sodium chloride co-crystals. Ultimately the crystal structure of the sarcosine.sodium chloride co-crystals could be resolved using these co-crystals obtained by direct evaporation. The atomic arrangement in the co-crystal is depicted in FIG. 3C.

Further crystallizations were performed using a supersaturation approach mediated by decreasing the temperature. Experiments were performed at molar ratio of sarcosine to sodium chloride of 1:1 (25.0 g:16.4 g) and 2:1 (33.5 g:11.0 g). The crystalline material obtained from the equimolar ratio turned out to be pure NaCl, but the crystals yielded by a solution with a 2:1 ratio gave an XRPD diffraction pattern identical to those produced by the sarcosine.sodium chloride.monohydrate co-crystals that were obtained by mechanochemical synthesis. Regarding the experimental procedure, the mixture of sarcosine and sodium chloride was dissolved in 20 mL of water at 70° C. over a period of 4 hours. Then the mixture was slowly cooled to 10° C. over 6 hours. Crystallization occurred during this cooling process at around 50° C. Afterwards, the mixture was maintained at 10° C. for the next 14 hours. The resulting crystals were filtered and dried in oven at 40° C. for 14 hours (yield of 42%).

### Example 8

### Single Crystal X-Ray Diffraction Analyses of Amino Acid.Sodium Co-Crystals

Single co-crystals of (L-serine)₂.sodium chloride, (D-serine)₂.sodium chloride and sarcosine.sodium chloride.H₂O, were analysed by X-ray diffraction. The atomic arrangement of the co-crystals were determined from diffraction data, collected at a temperature of 185 K using X-rays with a wavelength of 1.54180 A. Atomic position plots, as depicted in FIG. 3, were generated using the checkCIF/PLATON programme (A.L.Spek, Acta Cryst. 2009, D65, 148-155).

The data collection statistics, space group and unit cell parameters are summarised in Table 1.

TABLE 1

| | (L-serine)₂•sodium | (D-serine)₂•sodium | Sarcosine•sodium |
|---|---|---|---|
| Co-crystal | chloride | chloride | chloride•H₂O |
| Bond precision (Å) | 0.0025 | 0.0030 | 0.0020 |
| Temperature (K) | 183 | 185 | 182 |
| Cell - a, b, c (Å) | 10.12, 6.72, 8.47 | 10.13, 6.72, 8.48 | 7.45, 14.28, 6.54 |
| Cell - α, β, γ (°) | 90, 91.14, 90 | 90, 91.13, 90 | 90, 92.00, 90 |
| Volume (Å³) | 575.91 | 576.85 | 694.99 |
| Crystal system | Orthorhombic | Orthorhombic | Monoclinic |
| Space Group | C121 | C121 | P121/c |
| Empirical formula | C₆H₁₄N₂Na₁O₆Cl₁ | C₆H₁₄N₂Na₁O₆Cl₁ | C₃H₉Cl₁N₁Na₁O₃ |
| Mr (g mol⁻¹) | 268.63 | 268.63 | 165.55 |
| Formula units per cell (Z) | 2 | 2 | 4 |

### Example 9

### Dissolution Kinetics

The dissolution behaviour of (L-serine)₂.sodium co-crystals obtained by direct crystallisation from a saturated solution (Example 2) were tested by refractometry. In this experiment, test samples were added to 60 mL of water, and the extent of dissolution was measured while stirring at 500 rpm. Using a RFM300+ refractometer (Bellingham and Stanley), one measurement per second was recorded over a 50 second time course. Experiments were performed three times and the average value was calculated. The particle size was standardised in the range 100-200 μm.

The following samples were tested:

| Sample | Amount (g) |
|---|---|
| (L-serine)₂•NaCl co-crystal | 2.58 |
| NaCl | 0.56 |
| L-serine (anhydrous) | 2.02 |
| Physical mix of L-serine/NaCl | 2.02/0.56 |

The data presented here demonstrate that co-crystalline forms of sodium chloride with amino acids have similar dissolution kinetics in water to those of pure sodium chloride (the curves marked with triangles and diamonds). As depicted in FIG. 1, both NaCl (curve marked with triangles) and (L-serine)₂.sodium chloride co-crystals (curve marked with diamonds) reached 50% dissolution in less than 10 seconds, and reached 90% dissolution in around 25 seconds.

It is important to note that pure NaCl is rarely ingested on its own. For example, when food products are consumed, amino acids derived from food proteins will be present in the mouth. Thus, as opposed to the dissolution of NaCl in pure water, measuring the dissolution profile of NaCl in the presence of amino acids more accurately represents the conditions in the mouth during ingestion and mastication. Accordingly, the dissolution kinetics of a physical mixture of L-serine and NaCl was also measured.

In contrast to (L-serine)₂.sodium chloride co-crystals, the physical mixture of L-serine and NaCl exhibited a slower rate of dissolution. After 25 seconds only around 50% of the physical mixture had dissolved and it took more than 45 seconds before the physical mixture reached 90% dissolution (see FIG. 1—curve marked with crosses).

As discussed above, only the fraction of sodium chloride dissolved in saliva can interact with taste receptors and therefore the rate of dissolution is important for the perception of a salty taste. Thus, relative to a physical mix of amino acid and sodium chloride, the superior dissolution behaviour of amino acid.sodium chloride co-crystals will provide an enhanced salty taste.

### Example 10

### Preparation of Tablets for Sensory Evaluation

Tablets for sensory evaluation were prepared using a Romaco Kilian Styl'One single-stroke tablet press. Tablets had a diameter of 8 mm; the sodium chloride content per tablet was designed to be 25 mg. The tablets were prepared with three compressions of 300 ms and an interval of 200 ms.

Tablets containing (L-serine)₂.sodium chloride had a thickness of 2.0 mm and an average mass of 123.7 mg. Tablets containing a physical mix of L-serine and sodium chloride had a measured thickness of 1.9 mm and an average mass of 123.7 mg.

The powders used for preparing tablets comprising the physical mix of serine and sodium chloride were combined by gentle rotational mixing at reduced pressure (ca. 100 g in total mass, 30 min, 750 mPa). L-serine (anhydrous) and NaCl was combined at a 2:1 molar ratio, thereby matching the content of the (L-serine)₂.sodium chloride co-crystals.

Tablets were stored under nitrogen at ambient temperature. The sodium content was quantified in each tablet by ²³Na NMR. The tablets were also submitted to powder X-ray diffraction analysis after compaction to ensure that either that no co-crystalline phase had formed (physical mix tablets) or the desired co-crystalline phase did not change during the processing (co-crystal tablets).

### Example 11

### Sensory Evaluation

The gustatory profiles of the (L-serine)₂.sodium chloride co-crystal and L-serine/NaCl physical mix were evaluated by 11 trained panellists.

Each of the panellists received a tray with two tablets presented on plastic plates coded with random 3-digit numbers. The tablets had to be crunched with the front teeth and kept in mouth to dissolve slowly (method 1). Alternatively, tablets could be crunched with the front teeth and chewed constantly in the mouth until complete dissolution occurred (method 2).

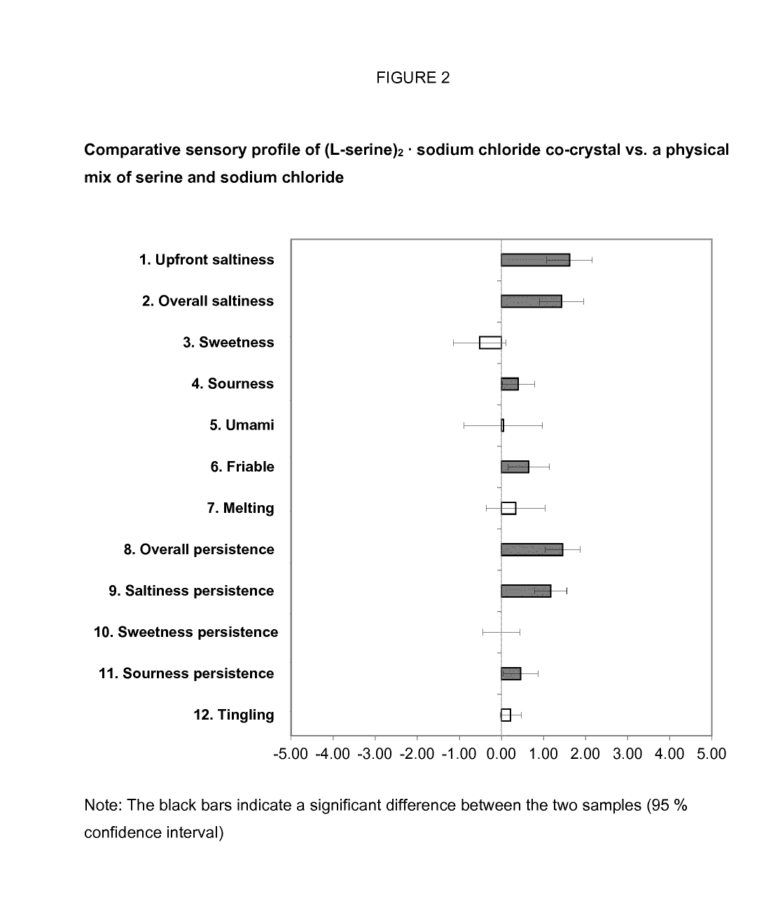

Afterwards the panellists were asked to rate the taste of the tablets in respect of the following 12 categories: upfront saltiness (1), overall saltiness (2), sweetness (3), sourness (4), umami (5), friable (6), melting (7), overall persistence (8), saltiness persistence (9), sweetness persistence (10), sourness persistence (11), and tingling (12). These ratings were combined to generate a comparative profile for (L-serine)₂.sodium chloride co-crystal tablets vs the L-serine/NaCl physical mix (FIG. 2).

Surprisingly, the taste of the co-crystals was perceived as significantly more salty than the corresponding physical mix both during and after consumption. Indeed, the (L-serine)₂.sodium chloride co-crystals were superior for all three characteristics relating to salty taste, i.e. upfront saltiness (1), overall saltiness (8) and saltiness persistence (9). Thus, it has been clearly demonstrated that amino acid.sodium co-crystals comprising L-serine provide an enhanced salty taste.

In summary, the present inventors have synthesised and characterised new co-crystalline forms of amino acids with sodium chloride. Surprisingly, these co-crystals exhibited similar dissolution behaviour to pure NaCl. Moreover, the rate of dissolution was significantly faster than that of a corresponding physical mix of amino acid and pure NaCl. It has also been demonstrated that the superior dissolution rate of (L-serine)₂.sodium chloride co-crystals results in an enhanced salty taste when consumed.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in chemistry, crystallography, food science or related fields are intended to be within the scope of the following claims.

1. A nutritional composition comprising serine.sodium chloride co-crystals.

2. A nutritional composition according to claim 1, wherein the serine.sodium chloride co-crystals comprise a 2:1 molar ratio of serine to sodium chloride.

3. A nutritional composition according to claim 1, wherein the co-crystal has the stoichiometry (L-serine)₂.sodium chloride.

4. A nutritional composition according to claim 1, wherein the serine.sodium chloride co-crystals comprise a 2:1 molar ratio of serine to sodium chloride.

5. A nutritional composition according to claim 1, wherein the serine co-crystal has the stoichiometry (D-serine)₂.sodium chloride.

6. A nutritional composition according to claim 1 comprising the serine.sodium chloride co-crystals in a concentration of: 0.01-40 wt %, based on the weight of the nutritional composition.

7. A nutritional composition according to claim 1 wherein it is in a form selected from the group consisting of a food product, a functional food product, a frozen food product, a dairy product, a microwaveable food product, a confectionery product, a culinary product, a nutritional supplement, or a pet food product, preferably wherein the food product is a pizza, a savoury turnover, a salted snack, a pretzel, chips, crisps, vegetable chips, sweet potato chips, wafers, nachos, a taco, salted nuts, an extruded snack, salted puffs, peanuts, popcorn, salted cookies, French fries, baked potatoes, cured meats, dried meat, breadsticks, olives, cheese, dried cheese, powdered cheese, sausages, pies, a ready-made baby food, stock powder, packet sauce, powdered sauce, ready-made sauce, ketchup, relish, marinade, pickled vegetables, dried vegetables, ready made soup, nut butter, a bread, a cookie, a chocolate bar, a caramel sauce, a filling, a candy, a frozen pizza, a frozen meal, a microwaveable meal, pasta, gluten-free pasta, a dough, a gluten-free dough, a frozen dough, a chilled dough, a bouillon cube, a gellified concentrated bouillon, an instant soup, a ready-meal, a snack, a culinary aid, a mayonnaise, a spread, a thickener, a tastemaker, a pretzel, a potato chip, a tortilla, a cracker, a rice cracker, a topping, a seasoning, a condiment, a flavour, a seasoning mix, a salt replacer, a table salt, a sea salt, a food preservative, a fortifying mix, and a mineral mix.

8. A nutritional composition according to claim 1 further comprising a nutrient selected from the group consisting of fat, protein, carbohydrate, vitamin, mineral and amino acid.

9. A co-crystal of L-serine and sodium chloride having a 2:1 molar ratio of L-serine to sodium chloride.

10. A co-crystal according to claim 9 having the stoichiometry (L-serine)₂.sodium chloride wherein the co-crystal is non-hydrated.

11. A co-crystal of (L-serine)₂.sodium chloride according to claim 9 having the following crystal unit cell parameters: a=10.1±0.5 Å, b=6.7±0.5 Å, c=8.5±0.5 Å; and α=90.0°, β=91.1±0.5°, γ=90.0°.

12. A method for the preparation or manufacture of a nutritional composition comprising adding an amino acid.sodium chloride co-crystal to a food product to produce the nutritional composition.

13. Method according to claim 12 wherein the amino acid.sodium chloride co-crystal is a serine.sodium chloride co-crystal.

14. Method according to claim 13 wherein the serine.sodium chloride co-crystals comprise a 2:1 molar ratio of serine to sodium chloride wherein the serine has the L- or D-configuration.

15. Method according to claim 13 wherein the co-crystal is (L-serine)₂.sodium chloride.
